(19) United States
(12) Patent Application Publication
(10) Pub. No.: US 2016/0012202 A1
(43) Pub. Date: Jan. 14, 2016

(54) PREDICTING THE RISKS OF MULTIPLE HEALTHCARE-RELATED OUTCOMES VIA JOINT COMORBIDITY DISCOVERY

(71) Applicant: International Business Machines Corporation, Armonk, NY (US)

(72) Inventors: Jianying Hu, Bronx, NY (US); Fei Wang, Ossining, NY (US); Xiang Wang, White Plains, NY (US)

(21) Appl. No.: 14/797,625

(22) Filed: Jul. 13, 2015

Related U.S. Application Data
(60) Provisional application No. 62/024,446, filed on Jul. 14, 2014.

(51) Int. Cl. G06F 19/00; G06N 7/00

(52) U.S. Cl. CPC G06F 19/3431; G06N 7/005

(57) ABSTRACT

A mapping matrix, which maps from original features of an electronic health record database to higher level latent factors, is initialized. For each of one or more target diseases, regression coefficients are updated over the higher level latent factors, based on said initialized mapping matrix, a data matrix containing said original features, and a label vector of corresponding responses. Said mapping matrix is updated based on said updated regression coefficients. Said steps of updating said regression coefficients and updating said mapping matrix are repeated until convergence is achieved, to obtain a final mapping matrix and a final set of regression coefficients.

### CROSS-REFERENCE TO RELATED APPLICATIONS

This application claims the benefit of U.S. Provisional Application Ser. No. 62/024,446 filed Jul. 14, 2014, entitled Multi-Task Learning Framework for Joint Disease Risk Prediction and Comorbidity Discovery, the complete disclosure of which is expressly incorporated herein by reference in its entirety for all purposes.

### FIELD OF THE INVENTION

The present invention relates to the electrical, electronic, and computer arts, and, more particularly, to healthcare, medical analytics, and the like.

### BACKGROUND OF THE INVENTION

Clinical risk prediction, also known as risk stratification, is an essential component of modern clinical decision support systems. It is attracting more and more attention in the recent years thanks to the adoption of Electronic Health Record (EHR) systems. State-of-the-art machine learning algorithms have been applied to massive EHR databases and promising results have been reported across the board. Generally speaking, a risk prediction model aims to estimate an individual's chance (or risk) of having an adverse outcome, such as onset of a disease. It also evaluates the contribution of individual medical features (risk factors) to the predicted risk. Most of the existing risk prediction models are single-task, which means that they only predict the risk of contracting one disease at a time. This becomes a limitation when, in practice, a health care provider is dealing with two or more diseases that share common comorbidities, risk factors, symptoms, etc. and the goal is to estimate the risk of several different diseases that are related to one another, e.g. hypertension and heart disease, diabetes and cataract, depression and obesity, etc. Single-task prediction models are not equipped to identify these associations across different tasks. Predicting these risks separately will likely cause the loss of crucial medical insights, such as confounding risk factors or hidden causes. Although multi-task learning has been extensively studied in the machine learning community, existing multi-task learning techniques cannot be directly applied to the problem of EHR-based risk prediction because the validity of each algorithm relies on the specific assumption it makes about task relatedness and these assumptions often fail to hold for many clinical applications.

Specifically, multi-task learning has been actively studied in the machine learning community for the past few years. The idea behind multi-task learning is that the tasks are related to each other and thus learning them jointly will lead to performance that is better than learning them separately. The fundamental difference between various multi-task learning techniques is how the task relatedness is formalized. One way is to assume the tasks are close to each other as if they are derived from the same underlying distribution or alternatively, assume the tasks have group structure and are similar within each group. The first assumption is often too strong for disease risk prediction due to the heterogeneity of diseases. The second assumption could be too difficult to validate in practice given our limited knowledge about the target diseases. Another way of formalizing task relatedness is to assume all tasks share a latent feature space. For instance, one can assume that all tasks share the same set of linear transformation of features. This is too strong an assumption for our problem because the overlap between different diseases could be partial, i.e. different diseases may share some comorbidities while having their own comorbidities. Some assume that all tasks can be represented by the combination of a common low-rank feature subspace and a task-specific structure. This assumption is also too restrictive for our application because it is not necessarily true that all diseases share a meaningful common basis. Rather, some diseases may have significant overlap whereas others may have little in common. Up to now, adapting any of these existing multi-task learning algorithms to risk prediction for multiple diseases has remained a non-trivial task.

### SUMMARY OF THE INVENTION

Principles of the invention provide a multi-task framework for predicting outcomes or risk for joint diseases and comorbidity discovery. In one aspect, an exemplary method includes the steps of initializing a mapping matrix which maps from original features of an electronic health record database to higher level latent factors; and, for each of one or more target diseases, updating regression coefficients over the higher level latent factors, based on said initialized mapping matrix, a data matrix containing said original features, and a label vector of corresponding responses. Further steps include updating said mapping matrix based on said updated regression coefficients; and repeating said steps of updating said regression coefficients and updating said mapping matrix until convergence is achieved, to obtain a final mapping matrix and a final set of regression coefficients.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects; for example, enhanced comorbidity identification and/or increased prediction accuracy.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts an intuitive example demonstrating the problem setting for multi-task risk prediction in the healthcare industry;

FIG. 2 includes a table with the definitions of notations in the multi-task framework of one or more embodiments of the present invention;

FIG. 3 shows the multi-task framework of one or more embodiments of the present invention;

FIG. 4 depicts the alternating minimization procedure used to optimize the formulation of one or more embodiments of the present invention;

FIG. 5 depicts the Augmented Lagrange Multipliers method used to optimize the formulation of one or more embodiments of the present invention;

FIG. 6 illustrates examples of International Classification of Diseases codes used by an embodiment of the present invention;

FIG. 7 shows comorbidity group results of an embodiment of the present invention;

FIG. 8 shows a table with comparative prediction measures of methods of measurement including an embodiment of the present invention;

FIG. 9 depicts a computer system that may be useful in implementing one or more aspects and/or elements of the invention; and

FIG. 10 is a system block diagram according to an aspect of the invention.

### DETAILED DESCRIPTION OF PREFERRED EMBODIMENTS

The framework of one or more embodiments of the present invention makes a mild assumption that will hold for a wide range of EHR data and diseases: The diseases share a small number of latent and distinct risk factors which can be represented by a combination of the medical features from the EHR database. The strength of the framework of the one or more embodiments of the invention comes from the fact that by combining multiple related diseases, noisiness and sparsity of the original medical features can be avoided to more accurately identify latent risk factors, which will in turn serve as better predictors for the target diseases.

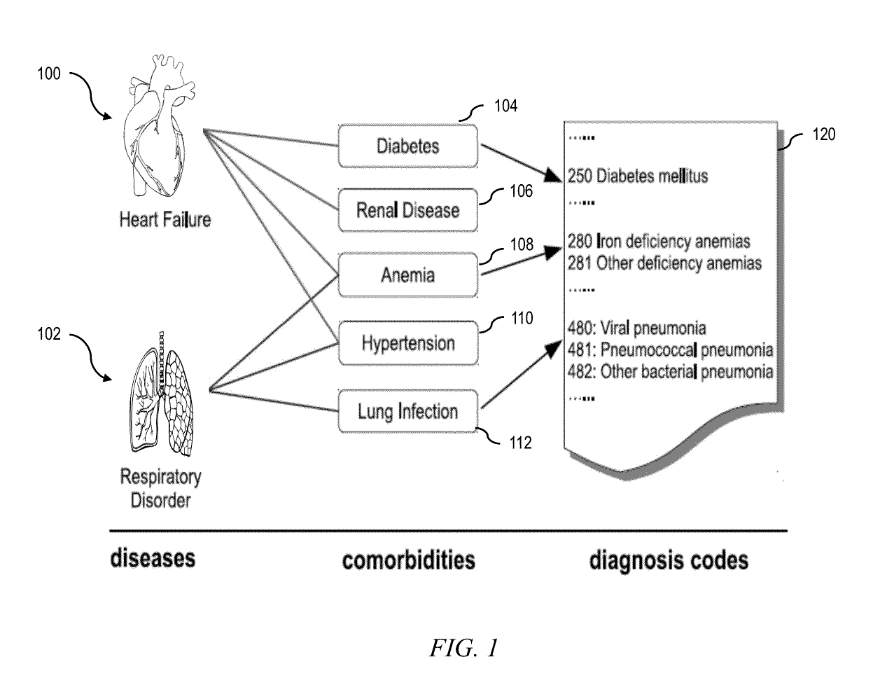

FIG. 1 shows relationships between individuals who are at risk of two diseases: heart failure 100 and respiratory disorder 102. Traditional risk models attribute the risks directly to the raw medical features from the EHR database 120, such as individual diagnosis codes, lab results, vitals, etc., which are often noisy and sparse. Under the framework of one or more embodiments of the present invention, the risks are attributed to certain higher-level latent factors. In the non-limiting example of FIG. 1, the higher-level latent factors are comorbidity groups 104-112; in other embodiments, the higher-level latent factors could be, for example, any type of risk factors including procedures, lab tests, or the like. In medical terms, comorbidity is the presence of additional conditions co-occurring with the target disease. The existence of comorbidities is a strong predictor and/or risk modifier for the target disease. The lines between diseases and comorbidities indicate a potential linkage. For instance, renal disease 106 is a common comorbidity for heart failure 100 and its presence will significantly increase the risk of heart failure onset. It is also well understood that our two target diseases, heart failure 100 and respiratory disorder 102, are related in terms of sharing some common comorbidities like anemia 108 and hypertension 110. Hence, studying them jointly helps to more accurately pinpoint the underlying comorbidities and consequently facilitate risk prediction. Lastly, note that well-defined comorbidities are distinct conditions and thus can be represented by distinct groups of features from the EHR database 120. The arrows in FIG. 1 show the mapping from comorbidities to recorded diagnosis codes. In other words, defining the comorbidities is equivalent to defining a grouping of the underlying medical features. According to one or more embodiments of the present invention, an optimization-based formulation is provided that simultaneously learns the comorbidity groups and predicts the risk for all diseases based on the identified comorbidities. The objective function is solved efficiently using an alternating minimization algorithm. For experimental purposes, the framework of one embodiment of the present invention was applied to a real EHR database with 5,204 patients who are at risk of Congestive Heart Failure (CHF) and Chronic Obstructive Pulmonary Disease (COPD). By using diagnosis codes as underlying features, the framework was able to identify a meaningful set of shared comorbidities for CHF and COPD and good prediction accuracy ensued.

Advantageously, one or more embodiments of the present invention implement a multi-task learning framework that is specifically designed for clinical risk prediction. The assumption made about task relatedness will hold for a wide range of EHR data and target diseases, while the common feature representation learned, namely comorbidity groups, is interpretable to medical practitioners because it is a grouping of underlying medical features.

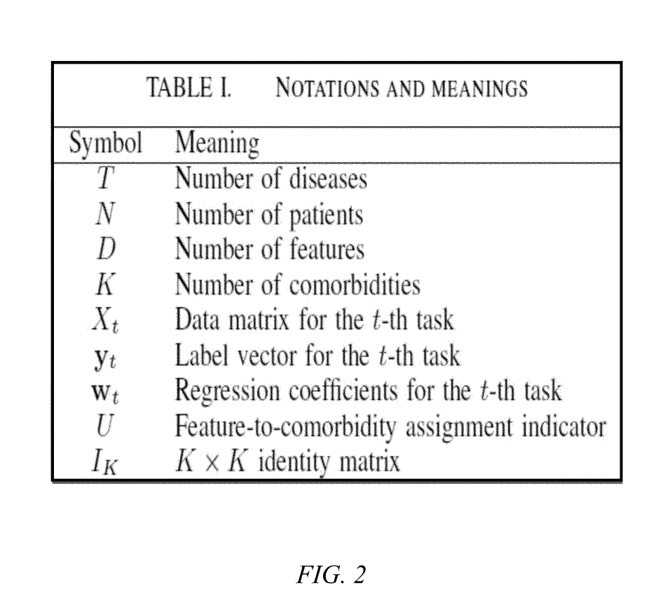

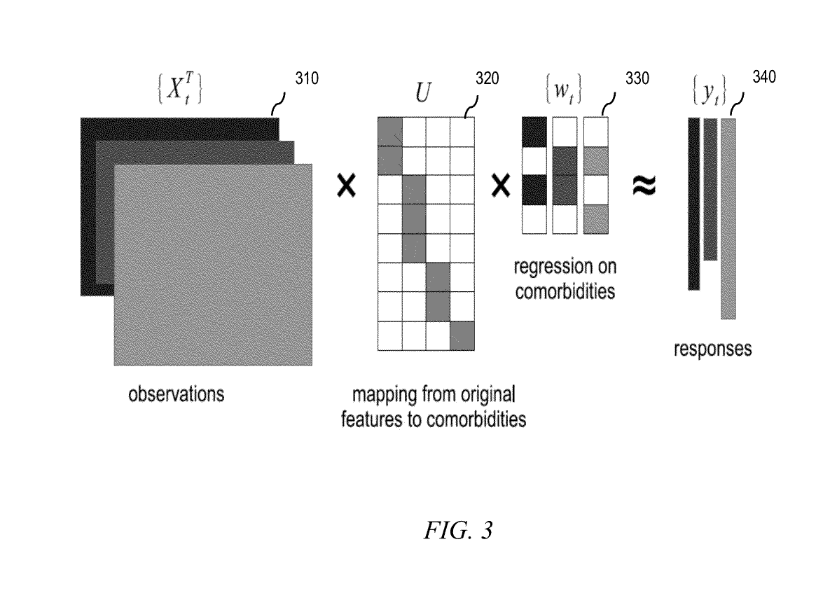

Table 1 of FIG. 2 lists the symbols used in this application. It is assumed that there are T target diseases (or “tasks”), D features from the EHR database 120, and N patients. K is the number of comorbidities. FIG. 3 shows the framework of one or more embodiments of the present invention. The medical features from the EHR database 120 are mapped to a set of comorbidity groups as defined by the assignment matrix U in 320 that is shared across all diseases. {Xₜ, yₜ} are inputs into the framework, the data matrix for the t-th task and the label vector for the t-th task, respectively, and the values of U and {wₜ}, the regression coefficients for the t-th task, are sought. In this illustration, D=8, K=4, T=3. For each task, there is an observation matrix Xₜε [symbol] ^{D×N} The (i, j)-th entry of Xₜ denotes the occurrence of feature i to patient j. yₜε{0,1}^{N} is the response vector for task t: (yₜ)ᵢ=1 means patient i is diagnosed with disease t, 0 otherwise. Uε{0, 1}^{D×K} is a mapping from the D medical features to K comorbidity groups. The rows of U sum up to one, which means each feature belongs to one comorbidity group. Note that wₜεR^{K} is the regression coefficients over the K comorbidity groups for the t-th disease. A positive entry in wₜ means that comorbidity contributes positively to the risk of disease t and vice versa.

By way of review and provision of additional detail, in FIGS. 2 and 3, the input 310 is a set of observational matrices. All these matrices share the same set of features. Those features will be aggregated into higher coarser level medical concepts with matrix U 320, and the medical concepts will be fed into the predictor 330 to get the responses 340.

The objective is to learn the comorbidity mapping U 320 and the regression coefficients {wₜ} 330 simultaneously and jointly over T diseases. Formally the formulation of the framework is written as:

$${arg min}_{{\{ {w}_{t} ∈ {ℝ}^{K} \}}_{U ∈ {\{ 0 , 1 \}}^{D \times K}}} {\sum }_{t = 1}^{T} ( \frac{1}{2 N} {‖ {y}_{t} - {X}_{t}^{T} {Uw}_{t} ‖}_{F}^{2} + λ {‖ {w}_{t} ‖}_{1} ) \\ s . t . {\sum }_{k = 1}^{K} {U}_{dk} = 1 , ∀ d = 1 , … , D \qquad ( 1 )$$

where ∥·∥_{F} Frobenius norm:

$${‖ A ‖}_{F}^{2} = {\sum }_{i , j} {A}_{ij}^{2}$$

and ∥·∥₁ is element-wise l1 norm:

$${‖ A ‖}_{1} = {\sum }_{i , j} \vert {A}_{ij} \vert .$$

λ>0 is a user-specified parameter.

The inputs are the Xₜ and yₜ values and the calculation happens at solving for the wₜ values and U. The first term inside the summation of Equation (1) is the empirical loss. Here, least squares were used for the simplicity of the formulation. Alternatively, it can be replaced with logistic loss without affecting the solvability of the objective. The second term is a regularizer that enforces sparsity on the regression coefficients wₜ. Intuitively this term “wants” each disease to be explained by a smaller number of comorbidities (thus a simpler explanation). Additional regularizers can be optionally added according to practical needs. The constraint term in Equation (1) says the rows of U should sum up to 1, which implies the K comorbidity groups are a disjoint partition of the D medical features. This is to make the comorbidity groups semantically distinct. Equation (1) is intractable due to the combinatorial nature of U. To overcome this, the constraint on U can be relaxed by allowing the entries in U to take real values. After the relaxation, the objective becomes:

$${arg min}_{{\{ {w}_{t} ∈ {ℝ}^{K} \}}_{U ∈ {ℝ}^{D \times K}}} {\sum }_{t = 1}^{T} ( \frac{1}{2 N} {‖ {y}_{t} - {X}_{t}^{T} {Uw}_{t} ‖}_{F}^{2} + λ {‖ {w}_{t} ‖}_{1} ) \\ s . t . {U}^{T} U = {I}_{K} \qquad ( 2 )$$

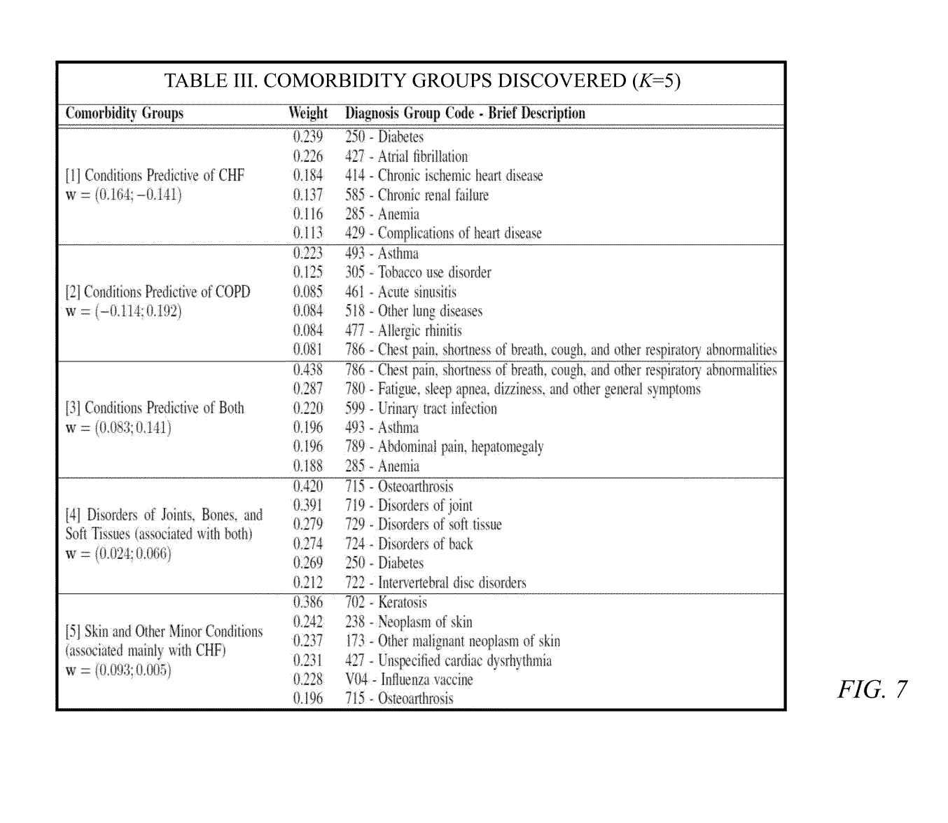

Note that the orthogonality constraint now replaces the original constraint in Equation (1) to enforce the independence among different comorbidities. Equation (2) now allows an efficient solution, which will be introduced in the following section. Note that after the relaxation, U is no longer a strictly disjoint partition of the original features. However, in practice, it usually generates semantically distinct comorbidity groups for medical interpretation due to the orthogonality. Referring to Table III of FIG. 7, in one or more embodiments, an exemplary method assumes all those different tasks share the same latent feature grouping representation, where U is the mapping matrix that maps those features to the feature groups. Then the predictor will be imposed on feature groups instead of the raw features.

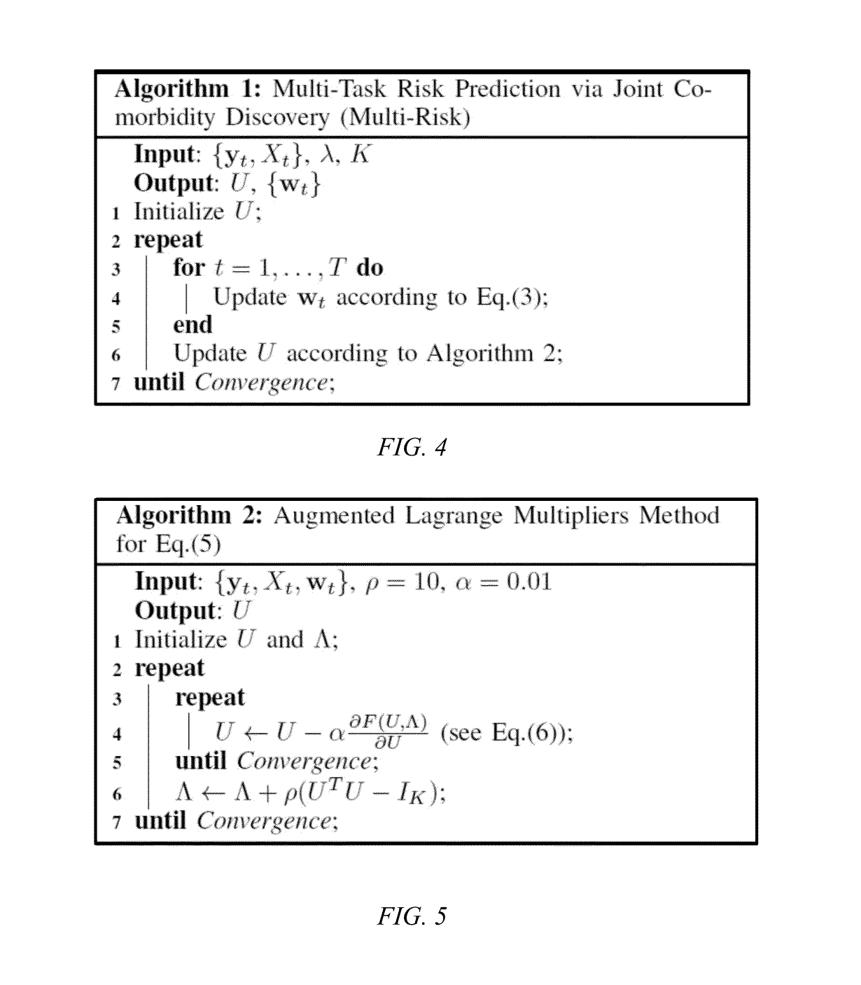

An efficient solution to the objective function in Equation (2) is provided as follows. The algorithm alternates between U and {wₜ} by fixing one and updating the other to minimize Equation (2) until a local optimum is reached. The alternating minimization procedure is summarized in Algorithm 1 shown in FIG. 4. The first line is input variables, including data feature matrix, data labels, trade-off parameter and number of feature groups. The second line is outputs, which include the feature mapping matrix and the prediction vectors. The feature mapping matrix is initialized at the first step, and then, alternatively, the prediction vector for each task is updated, and the feature mapping matrix is updated—this alternative updating is carried out iteratively until convergence.

When U is fixed, Equation (2) becomes:

$${arg min}_{\{ {w}_{t} ∈ {ℝ}^{K} \}} {\sum }_{t = 1}^{T} ( \frac{1}{2 N} {‖ {y}_{t} - {\ddot{X}}_{t}^{T} {w}_{t} ‖}_{F}^{2} + λ {‖ {w}_{t} ‖}_{1} ) \qquad ( 3 )$$

where \tilde{X}ₜ^{T}=Xₜ^{T}U. This is a set of T standard l1-regularized least squares regression problems and can be solved independently using a variety of ready-to-use solvers (given the teachings herein, the skilled artisan will be able to select one or more suitable ready-to-use solvers).

When {wₜ} is fixed, Equation (2) becomes

$${arg min}_{U ∈ {ℝ}^{D \times K}} {\sum }_{t = 1}^{T} \frac{1}{2 N} {‖ {y}_{t} - {X}_{t}^{T} {Uw}_{t} ‖}_{F}^{2} , s . t . {U}^{T} U = {I}_{K} \qquad ( 4 )$$

This sub-problem is solved by using the Augmented Lagrange Multipliers method (see Algorithm 2 of FIG. 5). In particular, this method explains the details on how to update U. The inputs include data matrix, data labels and the current prediction vectors, as well as two constants used for updating. The output is U. In the first step, initialize U and the Lagrangian multiplier matrix \Lambda. Step 3 to step 5 is the rule for updating U; step 6 is the rule for updating \Lambda. This process will be repeated until convergence.

The Lagrangian of Equation (4) is derived to be:

$$F ( U , A ) = {\sum }_{t = 1}^{T} \frac{1}{2 N} {‖ {y}_{t} - {X}_{t}^{T} {Uw}_{t} ‖}_{F}^{2} + tr ( Λ ( {U}^{T} U - {I}_{K} ) ) + \frac{ρ}{2} {‖ {U}^{T} U - {I}_{K} ‖}_{F}^{2} \qquad ( 5 )$$

where Λε [symbol] ^{K×K} are the Lagrange multipliers and ρ>0 is a given constant. To minimize the Lagrangian, we alternate between U and Λ (as summarized in Algorithm 2 of FIG. 5). Given Λ, use gradient descent to update U, where the gradient is:

$$\frac{\partial F ( U , Λ )}{\partial U} = {\sum }_{t = 1}^{T} \frac{1}{N} {X}_{t} ( {X}_{t}^{T} {Uw}_{t} - {y}_{t} ) {w}_{t}^{T} + U ( Λ + {Λ}^{T} ) + ρ \frac{\partial g ( U )}{\partial U} \qquad ( 6 )$$

where

$$g ( U ) = \frac{1}{2} {‖ {U}^{T} U - {I}_{K} ‖}_{F}^{2}$$

and its gradient is defined element wise as [20]:

$$\frac{\partial g ( U )}{\partial {U}_{ij}} = tr ( {( {U}^{T} U - {I}_{K} )}^{T} {C}_{ij} ) ,$$

where the matrix Cᵢⱼε [symbol] ^{K×K} defined as:

$${( {C}_{ij} )}_{kl} = \{ \begin{matrix}{U}_{il} & k = j , l \neq j \\ {U}_{ik} & k \neq j , l = j \\ 2 {U}_{ij} & k = j , l = j \\ 0 & k \neq j , l \neq j\end{matrix} .$$

Given U, updating Λ is straightforward (Line 6 of Algorithm 2 of FIG. 5).

To initialize the algorithm, the user specifies the desired number of comorbidity groups, which often comes from domain expertise. The user also needs to assign a positive value for λ, which is the weight for the sparsity regularizer. A larger λ means the user prefers a simpler model. In our experiment λ was set to 0.001 (given the teachings herein, the skilled artisan will be able to select suitable values of λ). The comorbidity assignment matrix U can either be initialized randomly or via an educated guess, based on domain-specific knowledge, as will be appreciated by the skilled artisan, given the teachings herein. In this implementation, the observation matrices are concatenated from all tasks and U is set to be the top-K principal components of the aggregated data matrix.

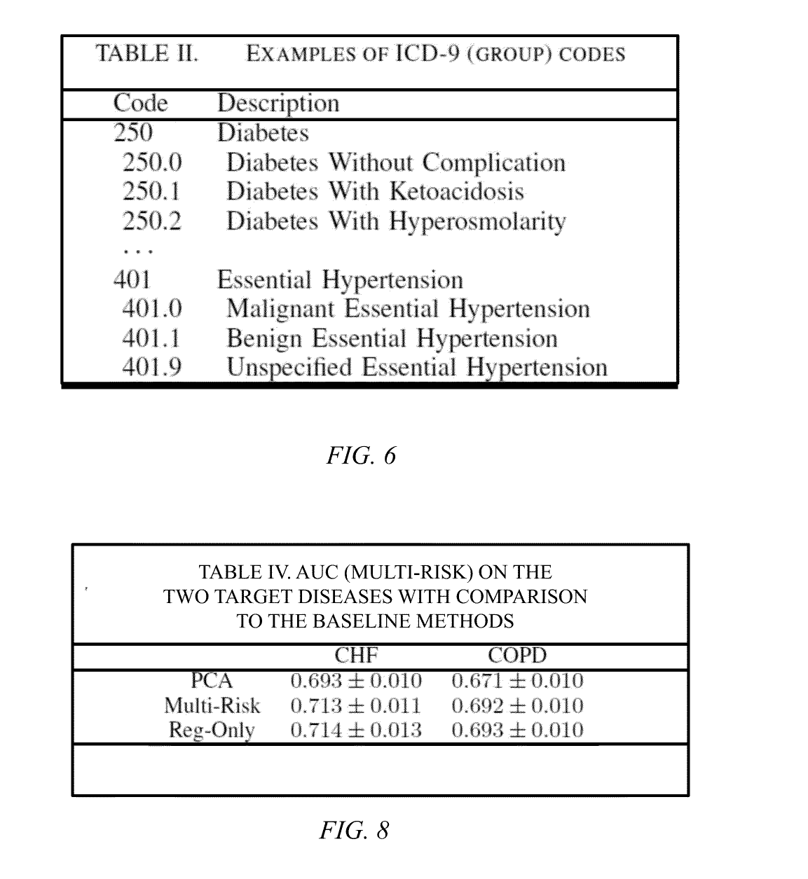

A dataset from a real EHR database was extracted with 2,019 case patients, among which 921 patients were diagnosed with Congestive Heart Failure (CHF) and 1,233 patients were diagnosed with Chronic Obstructive Pulmonary Disease (COPD). There were 135 patients who were diagnosed with both diseases. 3,185 control patients were selected who were not diagnosed with either disease, but were similar to the case patients in terms of age, gender, primary care physician, and health conditions (share a major medical condition with the case patient other than CHF and COPD). In total a patient cohort of 5,204 patients was used. For all patients, extracted medical features were gotten in the form of International Classification of Diseases, Ninth Revision (ICD-9) codes. Each ICD-9 code describes a unique medical condition that the patient was diagnosed with. In the experiment, the first three digits of the ICD-9 codes were used, also called ICD-9 group codes, which provide a higher-level description of groups of closely related ICD-9 codes (see Table II of FIG. 6 for some examples). In total, the dataset consisted of 1,230 distinct ICD-9 group codes. The task was to predict the early onset of CHF and COPD. For case patients, the day they were diagnosed with either CHF or COPD was set as the diagnosis date. Only the medical records that occurred from 540 days prior to the diagnosis date till 180 days prior to the diagnosis date were considered. In other words, about a year worth of data was used to make prediction at least half a year before onset. For control patients, the last day of their available records was set as the diagnosis date and the same rule was followed. In the end 232,968 medical records were collected, each of which was an ICD-9 group code related to a specific patient on a specific encounter. The data matrix was constructed using binary weighting, i.e. X_{dn}=1 means the d-th ICD-9 group code was assigned to the n-th patient, regardless of how many times. The data matrix was, as expected, extremely sparse with only 0.31% nonzero entries.

The two target diseases, CHF and COPD, are well known to have significant overlap in terms of common comorbidities, risk factors, and symptoms. In fact they are so similar that in practice they are often misdiagnosed for each other. One or more embodiments advantageously risk-stratify them jointly and identify not only the common comorbidities that they share but also, and more importantly, the discriminative comorbidities and conditions that distinguish them.

Table III of FIG. 7 shows comorbidity groups discovered by an exemplary embodiment of the invention (set K=5 for the clarity of presentation). For each comorbidity group, the ICD-9 group codes are displayed corresponding to the largest entries in Uₖ (second column of the table). Recall a large number means the feature is more closely associated with that comorbidity group. We also display the regression coefficients wₜ for each comorbidity group (first column of the table). A positive value means the comorbidity group contributes positively to the risk of disease t, and vice versa. Table III shows that the approach was able to identify two discriminative comorbidity groups (1 & 2) that distinguish CHF from COPD. For example, Atrial Fibrillation is a leading predictor for CHF but not COPD, whereas smoking is a leading predictor for COPD but not CHF. In addition to the discriminative comorbidities, the approach was able to identify a comorbidity group (3) that consists of common predictors for both diseases. For instance, fatigue and chest pain are common symptoms that can be experienced by both COPD and CHF patients. Furthermore, the approach discovered another two comorbidity groups, 4 for Osteoarthrosis and 5 for skin problems, which are common comorbidities of CHF and COPD but are not significant risk modifiers.

Next the performance of the approach of an embodiment of the present invention is shown in terms of prediction accuracy. The measurement used was Area Under Receiver Operating Characteristic Curve (AUC), which is a commonly used evaluation metric for risk prediction models. An AUC score of 1 means the prediction perfectly matches the ground truth whereas 0.5 means the prediction is no better than a random guess. The patient cohort was randomly split into two subsets: 60% for training and 40% for testing. The process was repeated 10 times with the mean and standard deviation reported in Table IV of FIG. 8. The multi-risk approach of the present invention was compared to two baseline methods. The first one is denoted PCA. Instead of learning U jointly from all diseases, PCA used a fixed U derived from the top-K principal components of the observation matrix X. PCA represents the best result one can get in the single-task learning setting where the comorbidity groups are learned without supervision. The second baseline is denoted Reg-Only, which means U is set to be an identity matrix ID. This is an extreme case of the framework of one or more embodiments of the invention where K=D and all features are used for regression (without grouping). Reg-Only represents the best result one can get where no comorbidity groups are discovered at all. For Multi-Risk and PCA, K was set as K=10. From Table IV it can be observed that, with joint comorbidity discovery, the present approach significantly outperformed PCA on both diseases (significance level 0.01). In fact, the comorbidity groups identified by PCA (not shown due to space limit) were also less interpretable than those identified by our approach (in Table III). This is not surprising because our framework is designed to identify the most discriminative comorbidity groups for all diseases via joint learning. On the other hand, there is no significant difference (significance level 0.01) between our approach and Reg-Only in terms of prediction accuracy. Recall that Reg-Only is designed to achieve the highest prediction accuracy possible without summarizing the original features into a small number of comorbidity groups. This demonstrates that the present approach is able to learn a succinct and interpretable representation of the data while retaining the prediction power achieved by using all the raw features.

Given the discussion thus far, it will be appreciated that, in general terms, an exemplary method, according to an aspect of the invention, includes the step of initializing a mapping matrix U, 320, which maps from original features of an electronic health record database to higher level latent factors (in a non-limiting example, comorbidities). A further step includes, for each of one or more target diseases, updating regression coefficients wₜ over the higher level latent factors, based on said initialized mapping matrix, a data matrix 310 containing said original features, and a label vector yₜ 340 of corresponding responses. Refer to FIG. 4 and equation (3). A still further step includes updating said mapping matrix based on said updated regression coefficients. Refer to algorithm (2) of FIG. 5. A still further step includes repeating said steps of updating said regression coefficients and updating said mapping matrix until convergence is achieved, to obtain a final mapping matrix and a final set of regression coefficients. Refer to FIGS. 4 and 5.

As noted, in a non-limiting example, said higher level latent factors comprise comorbidities.

In some embodiments, said updating of said mapping matrix comprises applying an augmented Lagrange multiplier method; for example, referring to FIG. 5, initializing said mapping matrix and a plurality of corresponding Lagrange multipliers; applying a gradient descent technique to iteratively update said mapping matrix, until convergence is achieved; updating said Lagrange multipliers by adding a constant times a difference of a transpose of said mapping matrix times said mapping matrix less an identity matrix (see line 6); and repeating said steps of applying said gradient descent technique and updating said Lagrange multipliers until convergence is achieved.

In one or more embodiments, said identity matrix I_{K} is square and the number of rows and columns is equal to the number of comorbidities (2 or more).

Some embodiments enforce sparsity on said regression coefficients during said updating of said regression coefficients (see discussion of λ).

In some cases, said original features comprise diagnosis codes.

In one or more embodiments, said original features of said electronic health record database comprise training data, and the U and wₜ obtained from training are used to predict outcomes for features of a non-training electronic health record database (i.e., data where the outcomes are not yet known).

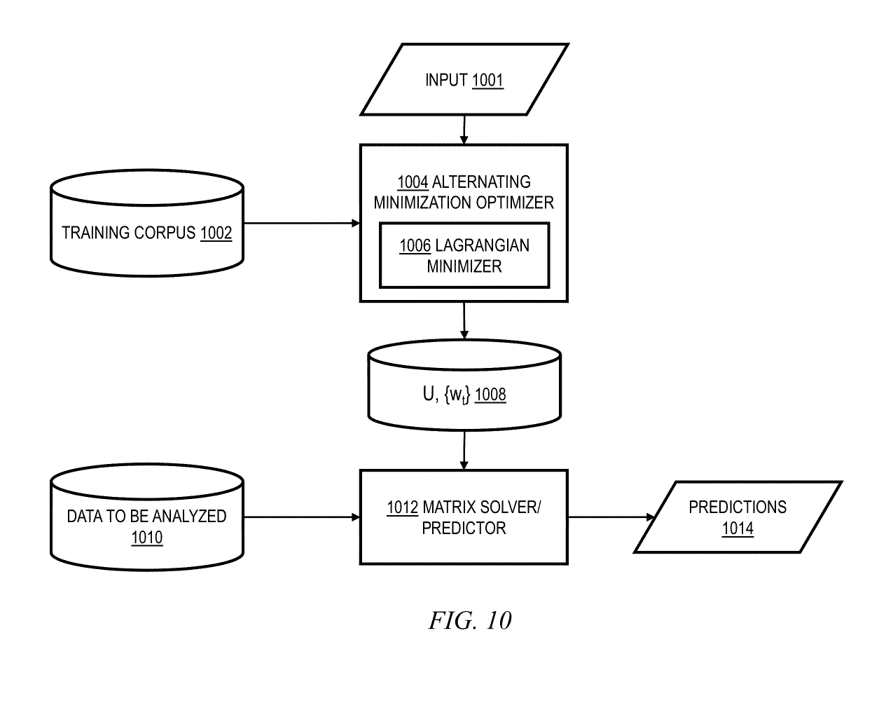

As discussed elsewhere with respect to FIG. 10, in some cases, said repeated steps of updating said regression coefficients and updating said mapping matrix are carried out by an alternating minimization optimizer module, embodied in a non-transitory computer readable medium, executing on at least one hardware processor (thus implementing optimizer 1004; sub-modules such as Lagrangian minimizer 1006 can be provided); further, using of said final mapping matrix and said final set of regression coefficients to predict said outcomes can be carried out by a matrix solver module, embodied in said non-transitory computer readable medium, executing on said at least one hardware processor (thus implementing matrix solver/predictor 1012).

In another aspect, an exemplary apparatus includes a memory (e.g., RAM part of memory 904 discussed below); at least one processor (e.g., 902 discussed below), coupled to said memory; and a non-transitory computer readable medium (e.g., hard drive or other persistent storage part of memory 904 discussed below) comprising computer executable instructions which when loaded into said memory configure said at least one processor to carry out or otherwise facilitate any one, some, or all of the method steps disclosed herein.

Some embodiments can be thought of as providing a method of simultaneously predicting risks of multiple health-related outcomes, including receiving healthcare diagnosis information; analyzing the healthcare diagnosis information for determining correlations between the outcomes; creating, from the determined correlations, shared groupings of underlying features of the healthcare diagnosis information; and predicting, using regression based on the shared groupings, the risks of the outcomes, wherein each feature grouping is a high-level medical concept (such as a morbidity or other pertinent medical features) that contributes to the outcomes.

One or more embodiments of the invention, or elements thereof, can be implemented, at least in part, in the form of an apparatus including a memory and at least one processor that is coupled to the memory and operative to perform exemplary method steps.

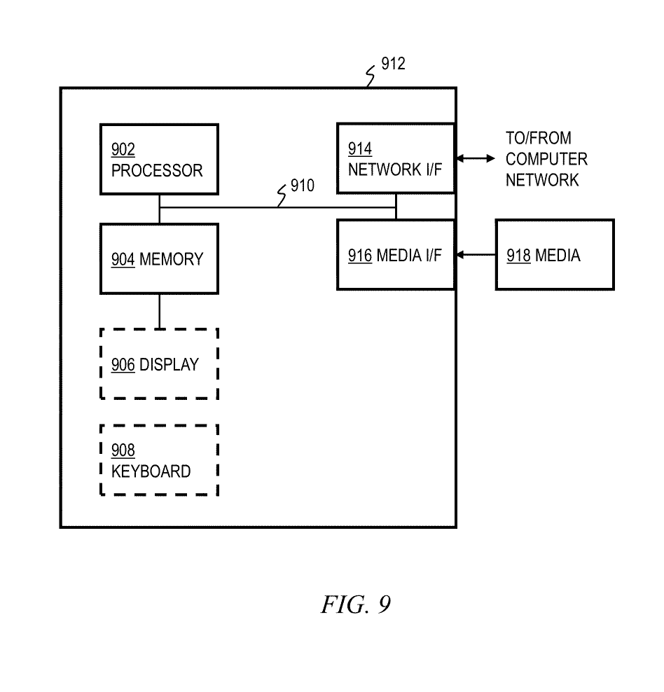

One or more embodiments can make use of software running on a general purpose computer or workstation. With reference to FIG. 9, such an implementation might employ, for example, a processor 902, a memory 904, and an input/output interface formed, for example, by a display 906 and a keyboard 908. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 902, memory 904, and input/output interface such as display 906 and keyboard 908 can be interconnected, for example, via bus 910 as part of a data processing unit 912. Suitable interconnections, for example via bus 910, can also be provided to a network interface 914, such as a network card, which can be provided to interface with a computer network, and to a media interface 916, such as a diskette or CD-ROM drive, which can be provided to interface with media 918.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 902 coupled directly or indirectly to memory elements 404 through a system bus 910. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 908, displays 906, pointing devices, and the like) can be coupled to the system either directly (such as via bus 910) or through intervening I/O controllers (omitted for clarity).

Network adapters such as network interface 914 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 912 as shown in FIG. 9) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the elements depicted in the block diagrams or other figures and/or described herein (e.g., elements in FIG. 10). The method steps can then be carried out using the distinct software modules and/or sub-modules of the system, executing on one or more hardware processors 902. Further, a computer program product can include a computer-readable storage medium with code adapted to be implemented to carry out one or more method steps described herein, including the provision of the system with the distinct software modules. More specifically, training corpus 1002 is stored in persistent storage and includes yₜ, and Xₜ. Alternating minimization optimizer 1004 obtains inputs 1001 (e.g., λ, K) and based on same and corpus 1002 solves for the final values of U and wₜ, stored in persistent storage at 1008. Optimizer 1004 implements the techniques of FIGS. 4 and 5, and may include suitable sub-modules such as Lagrangian minimizer 1006 (refer to FIG. 5). The final values of U and wₜ, stored in persistent storage at 1008, are then used by matrix solver/predictor 1012 to analyze the data 1010 (takes the place of observations 310) to predict the unknown outcomes/responses yₜ.

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising the steps of:
initializing a mapping matrix which maps from original features of an electronic health record database to higher level latent factors;
for each of one or more target diseases, updating regression coefficients over the higher level latent factors, based on said initialized mapping matrix, a data matrix containing said original features, and a label vector of corresponding responses;
updating said mapping matrix based on said updated regression coefficients; and
repeating said steps of updating said regression coefficients and updating said mapping matrix until convergence is achieved, to obtain a final mapping matrix and a final set of regression coefficients.

2. The method of claim 1, wherein said higher level latent factors comprise comorbidities.

3. The method of claim 2, wherein said updating of said mapping matrix comprises applying an augmented Lagrange multiplier method.

4. The method of claim 3, wherein said Lagrange multiplier method comprises:
initializing said mapping matrix and a plurality of corresponding Lagrange multipliers;
applying a gradient descent technique to iteratively update said mapping matrix, until convergence is achieved;
updating said Lagrange multipliers by adding a constant times a difference of a transpose of said mapping matrix times said mapping matrix less an identity matrix; and
repeating said steps of applying said gradient descent technique and updating said Lagrange multipliers until convergence is achieved.

5. The method of claim 4, wherein said identity matrix is square and has a number of rows and a number of columns equal to a number of said comorbidities, said number of said comorbidities being at least two.

6. The method of claim 4, further comprising enforcing sparsity on said regression coefficients during said updating of said regression coefficients.

7. The method of claim 2, wherein said original features comprise diagnosis codes.

8. The method of claim 2, wherein said original features of said electronic health record database comprise training data, further comprising using said final mapping matrix and said final set of regression coefficients to predict outcomes for features of a non-training electronic health record database for which said outcomes are to be predicted.

9. The method of claim 8, wherein:
said repeated steps of updating said regression coefficients and updating said mapping matrix are carried out by an alternating minimization optimizer module, embodied in a non-transitory computer readable medium, executing on at least one hardware processor; and
said using of said final mapping matrix and said final set of regression coefficients to predict said outcomes is carried out by a matrix solver module, embodied in said non-transitory computer readable medium, executing on said at least one hardware processor.

10. An apparatus comprising:
a memory;
at least one processor, coupled to said memory; and
a non-transitory computer readable medium comprising computer executable instructions which when loaded into said memory configure said at least one processor to:
initialize a mapping matrix which maps from original features of an electronic health record database to higher level latent factors;
for each of one or more target diseases, update regression coefficients over the higher level latent factors, based on said initialized mapping matrix, a data matrix containing said original features, and a label vector of corresponding responses;
update said mapping matrix based on said updated regression coefficients; and
repeat said steps of updating said regression coefficients and updating said mapping matrix until convergence is achieved, to obtain a final mapping matrix and a final set of regression coefficients.

11. The apparatus of claim 10, wherein said higher level latent factors comprise comorbidities.

12. The apparatus of claim 11, wherein said updating of said mapping matrix comprises applying an augmented Lagrange multiplier method.

13. The apparatus of claim 12, wherein said Lagrange multiplier method comprises:
initializing said mapping matrix and a plurality of corresponding Lagrange multipliers;
applying a gradient descent technique to iteratively update said mapping matrix, until convergence is achieved;
updating said Lagrange multipliers by adding a constant times a difference of a transpose of said mapping matrix times said mapping matrix less an identity matrix; and
repeating said steps of applying said gradient descent technique and updating said Lagrange multipliers until convergence is achieved.

14. The apparatus of claim 13, wherein said identity matrix is square and has a number of rows and a number of columns equal to a number of said comorbidities, said number of said comorbidities being at least two.

15. The apparatus of claim 13, wherein said instructions further configure said at least one processor to enforce sparsity on said regression coefficients during said updating of said regression coefficients.

16. The apparatus of claim 11, wherein said original features comprise diagnosis codes.

17. The apparatus of claim 11, wherein said original features of said electronic health record database comprise training data, and wherein said instructions further configure said at least one processor to use said final mapping matrix and said final set of regression coefficients to predict outcomes for features of a non-training electronic health record database for which said outcomes are to be predicted.

18. The method of claim 17, wherein:
said non-transitory computer readable medium comprising said computer executable instructions embodies: an alternating minimization optimizer module; and a matrix solver module;
said at least one processor is configured to carry out said repeated steps of updating said regression coefficients and updating said mapping matrix by executing said alternating minimization optimizer module; and
said at least one processor is configured to use said final mapping matrix and said final set of regression coefficients to predict said outcomes by executing said matrix solver module.

19. A non-transitory computer readable medium comprising computer executable instructions which when executed by a computer cause the computer to perform the method of:
initializing a mapping matrix which maps from original features of an electronic health record database to higher level latent factors;
for each of one or more target diseases, updating regression coefficients over the higher level latent factors, based on said initialized mapping matrix, a data matrix containing said original features, and a label vector of corresponding responses;
updating said mapping matrix based on said updated regression coefficients; and
repeating said steps of updating said regression coefficients and updating said mapping matrix until convergence is achieved, to obtain a final mapping matrix and a final set of regression coefficients.

20. The non-transitory computer readable medium of claim 19, wherein:
said higher level latent factors comprise comorbidities;
said original features of said electronic health record database comprise training data; and
said instructions when executed by said computer further cause said computer to perform the additional method step of using said final mapping matrix and said final set of regression coefficients to predict outcomes for features of a non-training electronic health record database for which said outcomes are to be predicted.
